(19) United States
(12) Patent Application Publication
(10) Pub. No.: US 2003/0097575 A1
(43) Pub. Date: May 22, 2003

(54) Information processing apparatus, display unit, digital content distributing system and digital content distributing/outputting method

(76) Inventors: Toru Owada, Yokohama (JP); Jun Kitahara, Yokohama (JP); Takeshi Asahi, Fujisawa (JP)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 09/988,156

(22) Filed: Nov. 19, 2001

(30) Foreign Application Priority Data
Nov. 17, 2001 (JP) 2000-351510

(51) Int. Cl. H04L 9/00

(52) U.S. Cl. 713/189

(57) ABSTRACT

The present invention protects the right of a digital content, and enables final output of the digital content in a form of stimulating user's visual and auditory desire. An information processing apparatus main body transfers a digital content (display data) encrypted by using an encrypted key information shared with a display unit while the display unit performs a decryption process on the display data transferred from the information processing apparatus main body by using the encryption key information. Herein, the display data transferred from the information processing apparatus main body to the display unit is encrypted only in a part thereof, e.g. display data is encrypted in an amount of several lines every several lines.

### BACKGROUND OF THE INVENTION

This invention relates to an art for dealing with the digital content requiring copyright protection and, more particularly, to a method for distributing and outputting a digital content to a destination information processing apparatus while preventing the unauthorized use due to duplication but stimulating visual-and-audible desire of a user not having an authorized right.

Recently, there is increasing demand to distribute value-added information of video image, sound, etc. in a digital form. In order to protect the copyright of a digital content, emphasis is placed upon preventing illegal copies. Because the digital content is readily copied and, if copied, free from deterioration in quality, there already are ill effects including copyright infringement caused by illegal copies.

Digital-content encryption is generally used as one of preventive measures against copying, wherein only the user acquired with authorized encryption key information is allowed to decrypt the encrypted digital content and make certain of the content thereof.

### SUMMARY OF THE INVENTION

However, in the case of simple encryption of a digital content, the encrypted digital content cannot be viewed at all unless having authorized encryption key information.

This is because the digital content, despite formatted to a certain format, has been broken in its digital-data structure due to simple encryption neglecting the format, thus making impossible for the digital-content-replaying software or hardware to interpret the data structure.

Accordingly, the user is not allowed to make sure of the content unless acquiring authorized encryption key information through purchasing a digital content or so. Thus, there exists high threshold for the user in purchasing a digital content.

In order to resolve such a problem, it is preferred to distribute a digital content in a form stimulating user's visual and auditory desire on the premise of right protection for the digital content.

Meanwhile, conventionally the encryption of a digital content has been on the route only toward the user's information processing apparatus. In the information processing apparatus, no copyright protection has been made with encryption on the route of output to the final output unit, such as the display unit.

Recently, the digital-input final output unit, such as the liquid crystal display, has been placed into general use in place of the analog-input final output unit, such as the conventional CRT (Cathode-Ray Tube). Thus, there exists fear that a digital content be illegally copied through the route of outputting to the final output unit.

Thus, it is an object of this invention to make it possible in the information processing apparatus to protect against illegal copying of a digital content in the route to the final output of the digital content.

Another object of the invention is to protect the right of a digital content at the information processing apparatus and, further, stimulate user's visual-and-auditory desire, thereby promoting the distribution and sale of the digital content.

According to the present invention, in an information processing apparatus at least having a processing apparatus and an output unit, the processing apparatus transfers to the output unit a digital content encrypted using an encrypted key information shared with the output unit while the output unit performs a decryption process on the digital content transferred from the processing apparatus by using the encryption key information.

Particularly, in the invention, the digital content to be transferred from the processing apparatus to the output unit is encrypted, with a formatting unit of the digital content in plaintext taken as one unit, in a part of the units as a subject of encryption.

### BRIEF DESCRIPTION OF THE DRAWINGS

FIG. 1 is a schematic configuration diagram of a digital content distributing system according to the present embodiment;

FIG. 2 is a schematic operation flowchart of a digital content distributing system according to the present embodiment;

FIG. 3 is a schematic configuration diagram of an information processing apparatus of the embodiment;

FIG. 4 is a schematic configuration diagram of the information processing apparatus of the embodiment;

FIG. 5 is an explanatory figure showing one example of a method for encrypting a digital content to be distributed from the digital content distributing apparatus;

FIGS. 6A to 6C are explanatory views showing display images where the digital content encrypted by the encrypting method shown in FIG. 5 is displayed on a display unit;

FIG. 7 is a schematic configuration diagram of an information processing apparatus of the embodiment;

FIG. 8 is a schematic configuration diagram of a display control unit of the embodiment;

FIG. 9 is a schematic configuration diagram of the display unit of the embodiment;

FIG. 10 is a schematic configuration diagram of the display unit of the embodiment;

FIGS. 11A to 11C are explanatory views showing one example of an encrypting method for display data to be outputted from a display control unit;

FIG. 12 is an explanatory view showing one example of an encrypting method for display data to be outputted from a display control unit;

FIG. 13 is a schematic configuration diagram of an information processing apparatus of the embodiment; and

FIG. 14 is an explanatory diagram showing a schematic operation of the information processing apparatus shown in FIG. 13.

### DETAILED DESCRIPTION OF THE INVENTION

Now, an embodiment of the invention will be explained with reference to the drawings.

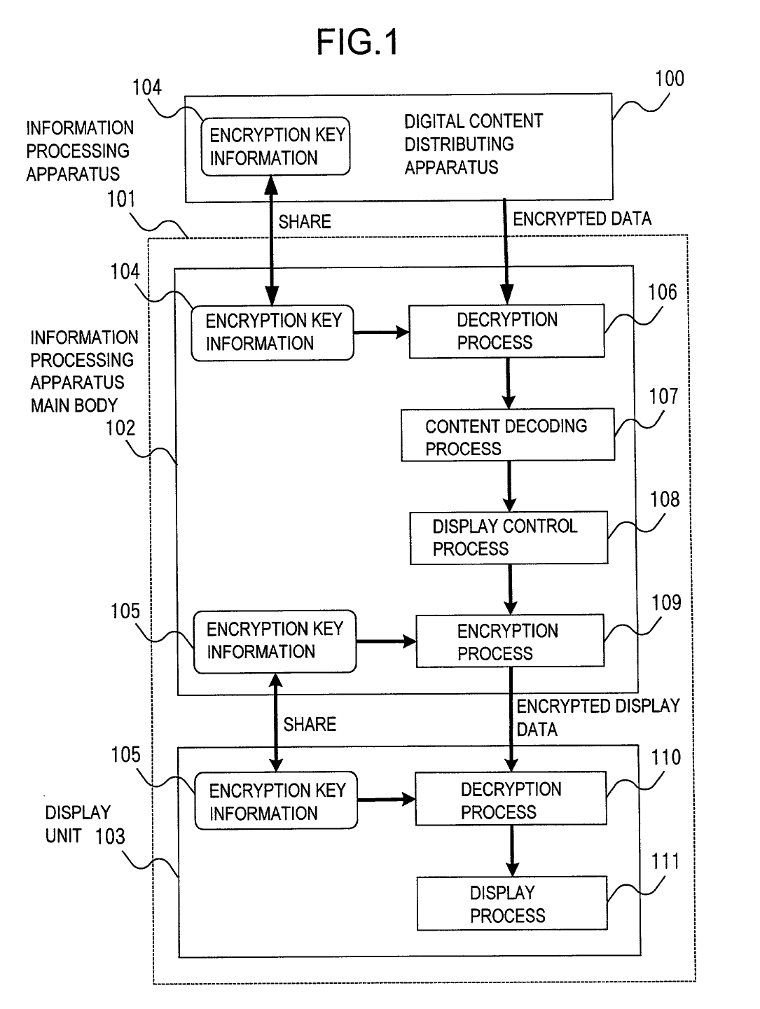

FIG. 1 is a schematic configuration diagram of a digital content distributing system according to the present embodiment.

In the figure, 100 is a digital content distributing apparatus, 101 an information processing apparatus, 102 an information processing apparatus main body and 103 a display unit.

The digital content distributing system of the embodiment is premised to protect the right of a value-added content to be distributed as digital data by the digital-content distributing apparatus 100. Namely, the digital content distributing system of the embodiment is to deal with digital data which includes the digital contents to be transferred between the digital content distributing apparatus 100 and the information processing apparatus main body 102 (distribution data) as well as the digital contents to be transferred between the information processing apparatus main body 102 and the display unit 103 (display data). Encryption is made on the above data to achieve protection of the content.

The digital content distributing system of the embodiment aims at distributing digital contents in a form to stimulate the visual-and-auditory desire of the user. Namely, the digital content distributing system of the embodiment makes it possible to stimulate user's visual-and-auditory demand through encrypted digital contents.

Specifically, the digital content to be transferred between the digital content distributing apparatus 100 and the information processing apparatus main body 102 is, for example, the digital data formatted by a predetermined compression scheme of JPEG (Joint Photographic Experts Group), MPEG (Moving Picture Experts Group) or the like, which is encrypted by a predetermined encrypting scheme, for example, of DES (Data Encryption Standard).

Herein, the digital content distributing apparatus 100 may be a network apparatus to distribute digital contents by way of a network or a recording medium recording a digital content, e.g. an optical disk medium or magnetic disk medium.

Namely, as far as the digital content to be distributed by the digital content distributing apparatus 100 is encrypted at the time of distribution from the digital content distributing apparatus 100, it is not necessary that encryption is processed by the digital content distributing apparatus 100.

Now, in the digital content distributing system of the embodiment, the digital content distributing apparatus 100 and the information processing main body 102 as shown in FIG. 1 have a function for sharing encryption key information 104 in order to encrypt/decrypt a digital content (distribution data) by a certain method.

Concerning the method for sharing encryption key information 104, there are various methods as under prior arts. Any method can be employed.

For example, there is included a method that the information processing apparatus main body 102 acquires encryption key information 104 from a network apparatus administering the encryption key information 104 used in encrypting the digital content. In this case, the network apparatus encrypts the encryption key information 104 by using a public key of the information processing apparatus main body 102, while the information processing apparatus main body 102 decrypt it by its own secret key.

Also, there is included a method that, for example, the encryption key information 104 used in encrypting the digital content (already encrypted) recorded on a magnetic disk is previously recorded in a non-volatile memory device within the information processing apparatus main body 102 in the manufacture of the information processing apparatus main body 102.

Similarly, as shown in FIG. 1, in the digital content distributing system of the embodiment, the information processing apparatus main body 102 and the display unit 103 have a function for sharing the encryption key information 105 to encrypt/decrypt a digital content (display data) by a certain method.

Concerning the method for sharing the encryption key information 105, there are various method as known arts similarly to the method for sharing encryption key information 104. Any method can be employed. For example, there is included a method that the display unit 103 acquires from the information processing apparatus main body 102 the encryption key information 105, which the information processing apparatus main body 102 has used in encrypting a digital content. In this case, the information processing apparatus main body 102 encrypts the encryption key information 105 by using a public key of the display unit 103 while the display unit 103 decrypts it by its own secret key.

Also, there is included a method that, for example, encryption key information 105 is previously recorded in respective internal non-volatile memory devices in the manufacture of the information processing apparatus main body 102 and display unit 103.

Meanwhile, in the digital content distributing system of the embodiment, the information processing apparatus main body 102 as shown in FIG. 1, possesses:

(1) a decryption function to perform a decryption process 106 on the encrypted part of the digital content distributed from the digital content distributing apparatus 100, by using encryption key information 104,

(2) a decoding function to perform a decoding process 107 of the digital content decrypted in the encrypted part,

(3) a display control function to perform a display control process 108 for converting the decoded digital content into the display data to be outputted at a bit rate as required by the display unit 103, and

(4) an encryption function to perform a partial encryption process 109 of the display data by using encryption key information 105.

Also, in the digital content distributing system of the embodiment, the display unit 103 as shown in FIG. 1 possesses:

(1) a decryption function to perform, using encryption key information 105, a partial decryption process 110 of the display data encrypted by the encryption function of the information processing apparatus main body 102, and

(2) a display function to perform a display process 111 of the decrypted display data.

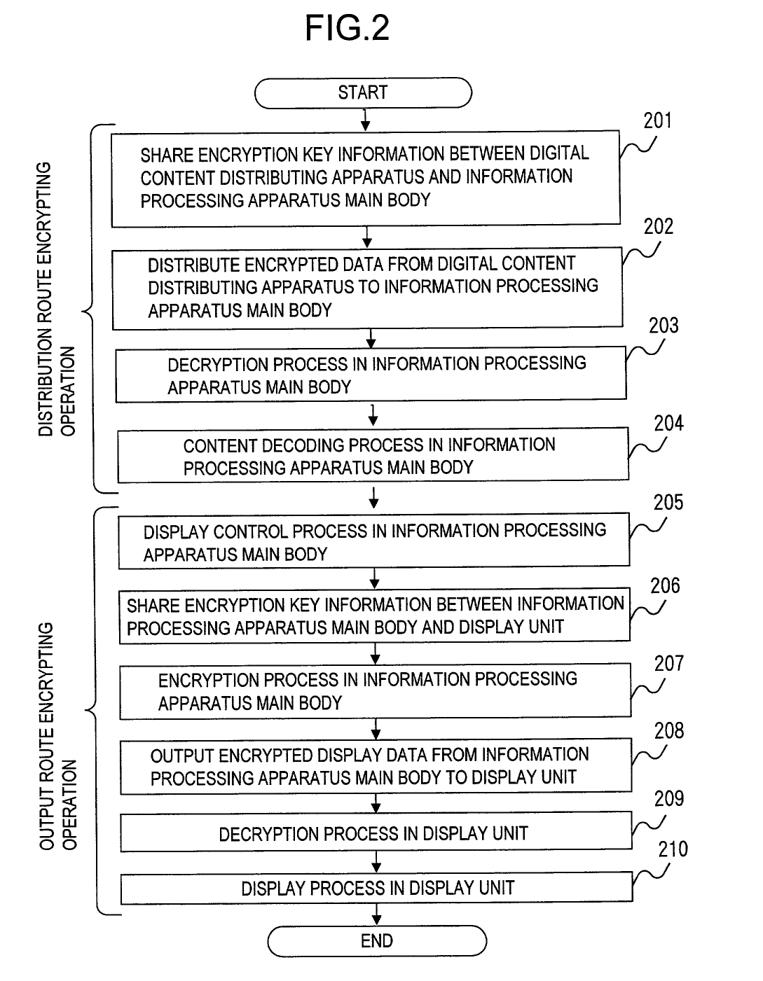

Next, explanation will be made on the schematic operation of the digital content distributing system of the embodiment by using FIG. 2.

FIG. 2 is a schematic operation flowchart of the digital content distributing system of the embodiment.

In FIG. 2, first the digital content distributing apparatus 100 and the information processing apparatus main body 102 share, by any method, the encryption key information 104 for encrypting/decrypting the digital content (distribution data) (step 201). As described above, the method for sharing the encryption key information 104 includes various known-art methods, any of which can be employed. Hence, the method is not defined herein.

Subsequently, the digital content distributing apparatus 100 distributes a digital content partly-encrypted by using the encryption key information 104, to the information processing apparatus main body 102 (step 202). As described before, as far as the digital content to be distributed by the digital content distributing apparatus 100 is encrypted at the time of distribution from the digital content distributing apparatus 100, it is not necessary that the encryption process is carried out by the digital content distributing apparatus 100.

Then, the information processing apparatus main body 102 performs a decryption process 106 using the encryption key information 104 on the encrypted part of the digital content distributed by the digital content distributing apparatus 100 (step 203). Due to the process of step 203, the information processing apparatus main body 102 can obtain a plaintext digital content therein.

Then, the information processing apparatus 102 performs a decoding process 107 on the digital content obtained by the process of step 203 (step 204). For example, in the case that the digital content obtained in the process of step 203 is MPEG data formatted by an MPEG scheme, the information processing apparatus main body 102 obtains therein motion image data comprising 30 frames per second by the process of step 204.

Then, a display control process 108 is made on the display data containing the motion image data obtained in the process of step 204, in order to output it at a bit rate as required by the display unit 103 (step 205). For example, in the case that the display unit 103 is a TFT (Thin Film Transistor) liquid crystal Display unit, in the process of step 205 the information processing apparatus main body 102 generates sequential display data having approximately 60-70 frames per second.

Then, the information processing apparatus main body 102 and the display unit 103 share, by any method, encryption key information 105 for encrypting/decrypting the digital content (display data) (step 206). As described above, the method for sharing the encryption key information 105 includes various known-art methods, any of which can be employed. Hence, the method is not defined herein.

Then, the information processing apparatus main body 102 performs an encryption process 109 on part of the display data generated in the process of step 205 by using the encryption key information 105 (step 207). Due to the process of step 207, the information processing apparatus main body 102 obtains therein display data partly encrypted.

Then, the information processing apparatus main body 102 outputs the partly-encrypted display data to the display unit 103 (step 208).

Then, the display unit 103 performs a decryption process 110 on the encrypted part of the display data outputted from the information processing apparatus main body 102, by using the encryption key information 105 (step 209). Due to the process of step 209, the display unit 103 obtains therein plaintext display data.

Then, the display unit 103 carries out a display process 111 on the display data obtained by the process of step 209 (step 210). Due to the process of step 210, displayed is the display data containing the motion image data obtained by the process of step 204.

As in the above, by the processes of step 201 to step 210, the digital content distributed from the digital content distributing apparatus 100 is displayed on the display unit 103.

Note that, among the operations of the digital content distributing system of the embodiment, the operation to be realized by the process of step 201 to step 204 is, hereinafter, referred to as “distribution-route encryption” and the operation to be realized by the process of step 205 to step 210 is as “output-route encryption”.

Meanwhile, the process of step 206 may be prior to or concurrent with a distribution-rote encrypting operation. Also, the process of step 205, step 206 and step 207 may be reversed in order in accordance with the configuration of the information processing apparatus 101.

Next, explanation will be made on the detail of the distribution-route encrypting operation.

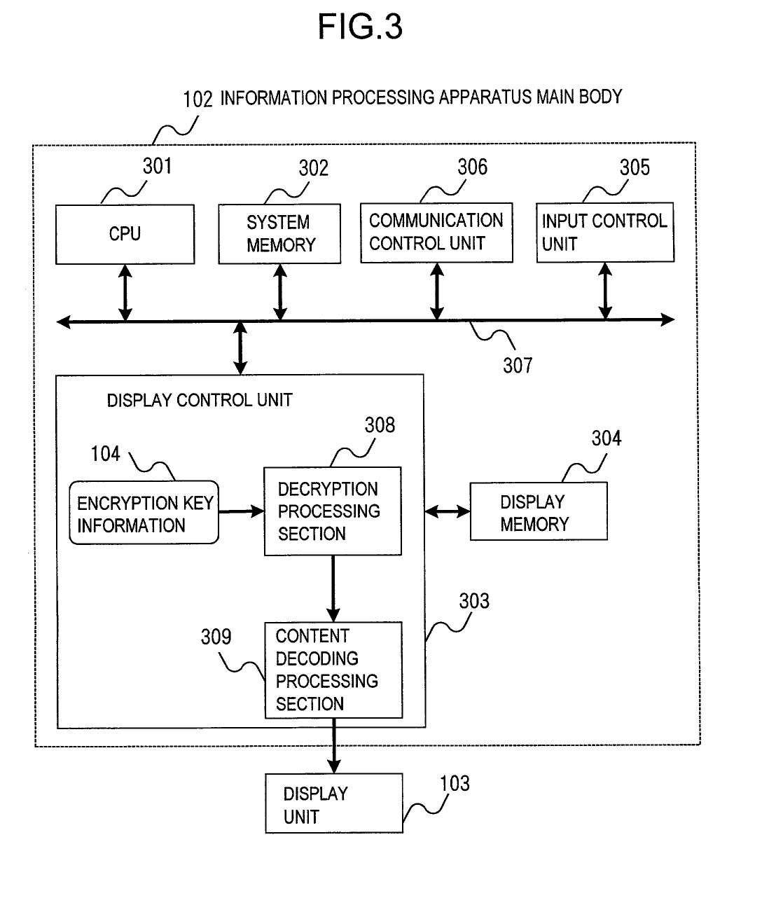

First, the schematic operation of the information processing apparatus 101 of the invention is explained using FIG. 3.

FIG. 3 is a schematic configuration diagram of the information processing apparatus 101 according to the embodiment.

FIG. 3 shows a display-concerned section of the information processing apparatus 101, such as a personal computer (PC), in a part concerning a distribution route encrypting operation.

In the figure, 102 is an information processing apparatus main body, 103 a display unit, 104 encryption key information, 301 a central processing unit (CPU), 302 a system memory, 303 a display control unit, 304 a display memory, 305 an input control unit, 306 a communication control unit, 307 a data bus, 308 a decryption processing section and 309 a content-decoding processing section.

In FIG. 3, in the case that the digital content distributing apparatus 100 is a network apparatus, a digital content is inputted to the communication control unit 306 according to an instruction by the CPU 301. Where the digital content distributing apparatus 100 is a recording medium, a digital content is inputted to the input control unit 305 according to an instruction by the CPU 301. The digital content inputted to the communication control unit 306 or input control unit 305 is inputted to the display control unit 303 through the data bus 307 according to an instruction by the CPU 301.

In the display control unit 303, the decryption processing section 308 performs a decryption process 106 on the encrypted part of the input digital content by using the encryption key information 104 held within the display control unit 303, thereby obtaining a plaintext digital content in the display control unit 303. Subsequently, the content-decoding processing section 309 performs a decoding process 107 on the decrypted digital content, thereby obtaining a decoded digital content in the display control unit 303.

The above operations correspond to distribution route encrypting operation. The output route encrypting operation will be referred later.

Note that the decryption processing section 308 and content-decoding processing section 309 can be implemented as hardware within the display control unit 303 or as software by providing its own CPU and memory within the display control unit 303.

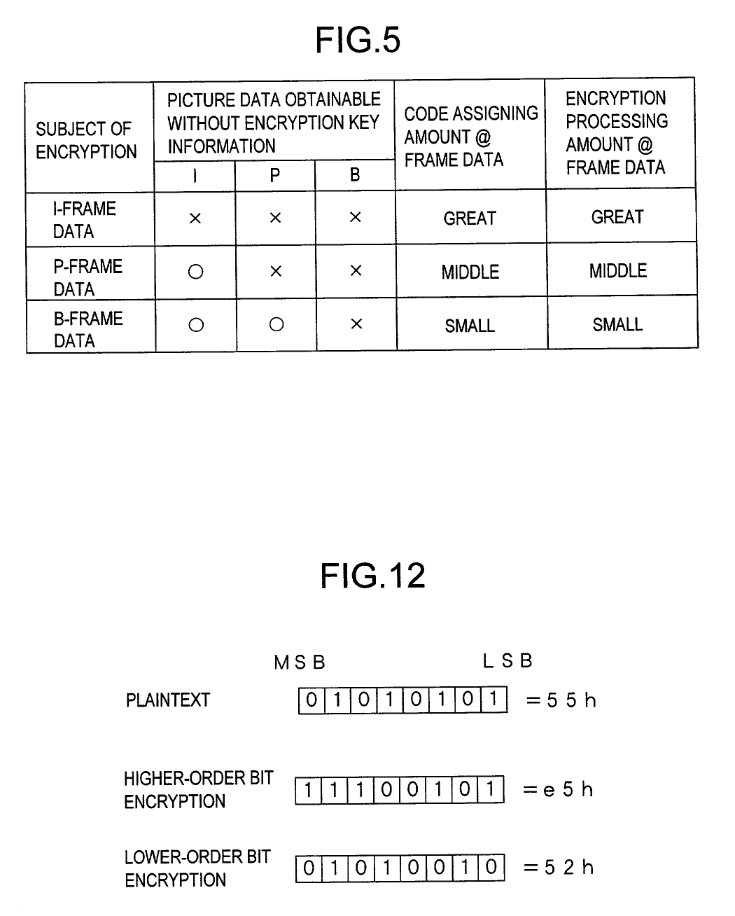

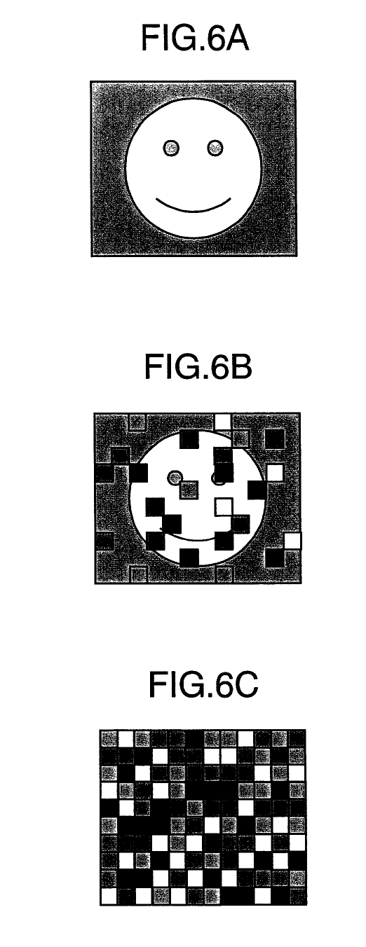

Now, explanation will be made on one example of a method for the digital content to be distributed by the digital content distributing apparatus 100 by the distribution route encrypting operation, using FIG. 5 and FIG. 6.

FIG. 5 is an explanatory figure showing one example of a method for encrypting the digital content to be distributed from the digital content distributing apparatus 100. FIG. 6 is an explanatory view showing a display image in the case that the digital content encrypted by the encryption method shown in FIG. 5 is displayed on the display unit 103.

FIG. 5 and FIG. 6 illustrate examples where the digital content is MPEG data.

In MPEG-schemed compression, the motion image data configured with m×n pixels per frame and k frames per second is, for example, comprised of three frames, i.e. I frame, P frame, and B frame.

(1) I Fame

In the I frame, the image data with I frame is divided into a plurality of 8×8-pixel blocks. Each block is subjected to orthogonal transformation process into frequency region data and thereafter quantized for data compression. Coding has been made only on the data within the original frame, in the I frame. From I frame data, one-frame data is obtained by a development process.

(2) P Frame

In the P frame, data compression is made with inter-frame anticipation in a forward direction. Coding has been made using differential information from I frame in the P frame. For restoring the original frame, P frame data and I frame data for the original image are required. Namely, image data cannot be obtained with only the P frame data.

(3) B Frame

In the B frame, data compression is made with bi-directional inter-frame anticipation. Coding has been made using differential information from I frame and P frame, in the B frame. For restoring original frame, P frame data, and I frame and B frame data for the reference image are required. Namely, image data cannot be obtained with only the B frame data.

Meanwhile, the code-assignment amount for I-picture data decreases in the order of I frame, P frame and B frame, as shown in FIG. 5. Motion image data is encoded in the order, e.g. IBB, PBB, PBB, IBB, PBB and PBB.

The following three methods can be considered as methods for encrypting the MPEG data having the above character.

(1) First Encryption Method

The first encryption method includes a method to encrypt only I frame data. The first encryption method may further be a method that encryption is made/not made for each block that compression is based on or/and a method encryption is made/not made for each of high frequency region data/low frequency region data, by putting an eye on the frequency component within the block regarded as compression unit.

First, explaining the former method (method to encrypt/not to encrypt each compression-based block), where the method of encryption is carried out, for example, on the original image shown in FIG. 6A, blocks are taken as a subject of encryption process. A certain block is encrypted and another block is not encrypted.

The MPEG data encrypted by the present method, unless performing a decryption process using encryption key information 104, provides an image as shown in FIG. 6B when displayed on the display unit 103. In the present method, the original image can be controlled in contaminated degree by increasing and decreasing the number of encrypting blocks, making possible to freely vary what degree of disclosure is to do.

Next, explaining the latter method (method to encrypt/not to encrypt each of high frequency region data/low frequency region data), where the method of encryption is carried out, for example, on the original image shown in FIG. 6A, the low frequency region data within the block is taken as a subject of encryption process. Then, the low frequency region data in each block is encrypted while the high frequency region data is not encrypted. The MPEG data encrypted by the present method, unless performing a decryption process using encryption key information 104, provides an image as shown in FIG. 6C when displayed on the display unit 103.

Encrypting the low frequency region data greatly contaminates the original image as shown in FIG. 6C, making difficult observation of the original image. However, encrypting the high frequency region data provides an image having noise superposed thereon the original image although not shown.

The present method can control the original-image contamination degree by selecting a frequency region in encryption, making possible to freely vary what degree of disclosure is to do. Also, instead of placing all the blocks under a subject of encryption process, part of blocks may be placed under a subject of encryption process.

In the case that only I frame data is encrypted by the first encryption method, I frame data cannot be restored in the absence of encryption key information 104. Consequently, as shown in FIG. 5, while the P frame data and B frame data that are differential information from 1 frame data are not encrypted, decoding is impossible. For example, the motion image data encoded in the order of IBB, PBB, PBB, IBB, PBB, PBB, in the absence of encryption key information 104, results in xxx, xxx, xxx, xxx, xxx, xxx (x means failure in normal decryption/decoding). Thus, no original image can be obtained in any frames.

(2) Second Encryption Method

The second encryption method includes a method to encrypt P frame data only. The second encryption method, similarly to the first encryption method, may further be a method that encryption is made/not made for each block regarded as compression unit, and a method encryption is made/not made for each of high frequency region data/low frequency region data by putting an eye on the frequency component within the block regarded as compression unit.

In the case that only P frame data is encrypted by the second encryption method, P frame data cannot be restored in the absence of encryption key information 104. Consequently, as shown in FIG. 5, while the B frame data as differential information on I-picture and P frame data is not encrypted, decoding is impossible. For example, the motion image data encoded in the order of IBB, PBB, PBB, IBB, PBB, PBB, in the absence of encryption key information 104, results in Ixx, xxx, xxx, Ixx, xxx, xxx (x means failure in normal decryption/development). Thus, the obtainable normal image frames are on the I frame data.

(3) Third Encryption Method

The third encryption method includes a method to encrypt B frame data only. The third encryption method, similarly to the first encryption method, may be a method that encryption is made/not made for each block regarded as compression unit, and a method encryption is made/not made for each of high frequency region data/low frequency region data by putting an eye on the frequency component within the block regarded as compression unit.

In the case that only B frame data is encrypted by the third encryption method, B frame data cannot be restored in the absence of encryption key information 104 as shown in FIG. 5. For example, the motion image data encoded, for example, in the order of IBB, PBB, PBB, IBB, PBB, PBB, in the absence of encryption key information 104 results in Ixx, Pxx, Pxx, Ixx, Pxx, Pxx (x means failure in normal decryption/development). Thus, the obtainable normal image frames are only on I frame data and Pframe data.

Although three methods were explained above as methods for encrypting MPEG data, these methods may be arbitrarily combined in an arbitrary way.

According to the digital content distributing system of the embodiment, the distribution route encrypting operation selects the data as a subject of encryption process to partly perform encryption instead of simply encrypting the digital content. Accordingly, where having no authorized encryption key information 104, the original image is partly contaminated. The digital content partly contaminated, because loses its value, makes it possible to prevent the digital content from being illegally copied. Also, the partial disclosure of a digital content stimulates user's visual and auditory desire, making possible to prompt him or her to completely viewing the digital content.

Particularly, in the digital content distributing system of the embodiment, when selecting data as a subject of encryption process, attention is paid to its format. Namely, where the digital content is taken merely as a bit string for a subject of encryption process, such data structures as headers, payloads and footers are all lost, thus making impossible the utilization as a digital content. In the digital content distributing system of the embodiment, however, instead of dealing with the digital content as a mere bit string, the data for encrypting is selected in accordance with a part of a format including a meaning. This makes possible contamination in part of data instead of the entire thereof.

Also, according to the digital content distributing system of the embodiment, the distribution route encryption operation utilizes the encryption process using encryption key information 104 for data contamination. Accordingly, in order to stimulate user's visual-and-auditory desire, there is no need to prepare a partly contaminated digital content separately from the complete digital content. Thus, it is possible to reduce the cost required to distribute/storage the digital content.

Furthermore, according to the digital content distributing system of the embodiment, the distribution route encrypting operation uses only a part of the digital content as a subject of encryption process to avoid the encryption process on the entire digital content, thereby reducing the amount of encryption process/decryption process. Note that contamination degree and process amount are in a trade-off relationship, and therefore either one can be priori to the other one.

As explained above, according to the digital content distributing system of the embodiment, the distribution route encrypting operation makes it possible to stimulate user's visual-and-auditory desire while protecting copyright over the digital-content distribution route.

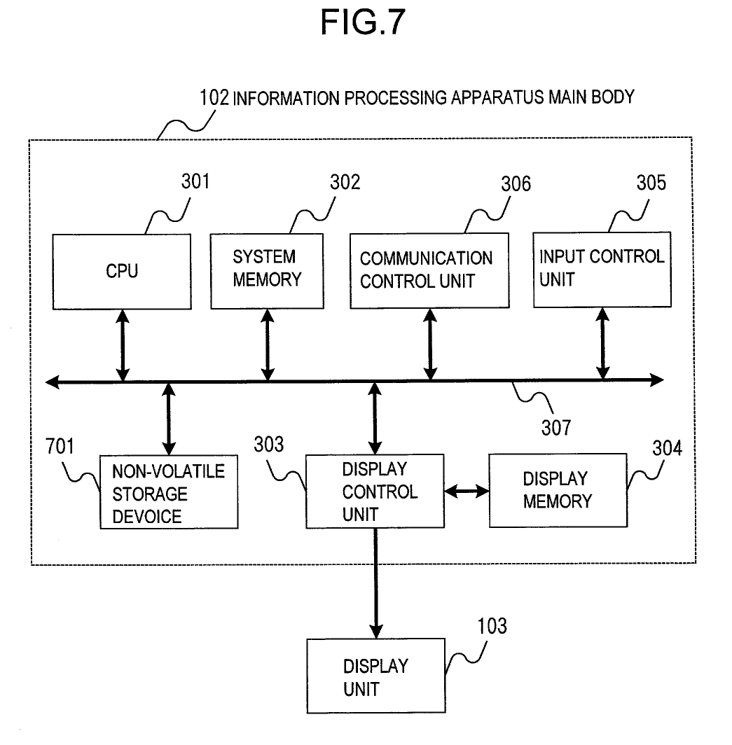

Incidentally, the information processing apparatus 101 of the embodiment can be configured as shown in FIG. 7 instead of the configuration shown in FIG. 3 so that the decryption processing section 308 and content decoding processing section 309 shown in FIG. 3 can be realized with software.

FIG. 7 is another schematic configuration diagram of an information processing apparatus 101 according to the present embodiment.

As same as FIG. 3, FIG. 7 shows only a display-concerned section of the information processing apparatus 101, such as a PC, in a part concerning a distribution route encrypting operation.

In the figure, the same constituting units as those of FIG. 3 are attached with the same reference numerals. 701 is a non-volatile storage device.

In the information processing apparatus 101 configured shown in FIG. 7, a CPU 301 realizes the operation of the decryption processing section 308 and content-decoding processing section 309 shown in FIG. 3 by loading and executing a program on a system memory 302.

In FIG. 7, in the case the digital content distributing apparatus 100 is a network apparatus, a digital content is inputted to the communication control unit 306 according to an instruction by the CPU 301. Where the digital content distributing apparatus 100 is a recording medium, a digital content is inputted to the input control unit 305 according to an instruction by the CPU 301. The digital content, inputted to the communication control unit 306 or input control unit 305, is inputted to the system memory 302 through the data bus 307 according to an instruction by the CPU 301.

The CPU 301 performs a decryption process 106 on the encrypted part of the inputted digital content by using encryption key information 104, thereby obtaining a plaintext digital content on the system memory 302. Subsequently, the CPU 301 carries out a decoding process 107 on the decrypted digital content, thereby obtaining a decoded digital content. The obtained digital content is inputted to the display control unit 303.

Herein, the encryption key information 104 in the explanation using FIG. 3 is held within the display control unit 303, the encryption key information 104 in the information processing apparatus 101 shown in FIG. 7 is held in the non-volatile memory device 701.

Also, although the information processing apparatus 101 of the embodiment is configured having the information processing apparatus main body 102 and display unit 103 both in FIG. 3 and in FIG. 7. However, the information processing apparatus main body 102 and the display unit 103 can be made in an integrated configuration. Namely, the information processing apparatus 101 of the embodiment may be provided as a portable information terminal termed so-called PDA (Personal Digital Assistant) or the like.

Generally, because the portable information terminal is often configured using a CPU comparatively low in performance or a low-capacity memory, there is a problem that encryption process, which is a comparatively heavy load process, imposes a heavy burden on the portable information terminal.

Accordingly, by using a portable information terminal involving such problem in the digital content distributing system of the embodiment, the digital content encrypted in a part thereof instead of the entirety can be dealt with thereby realizing the both of copyright protection and user's visual-and-auditory desire as aimed at by the invention. In addition, obtained is a load-reducing effect due to the reduction in encryption processing amount. Particularly, where the portable information terminal realizes the encryption process on software, there is no need to mount a high-performance CPU or large-capacity memory for encryption processing, resulting in reduction in cost and power consumption. Meanwhile, where the portable information terminal has the hardware for encryption processing, the processing speed required for the encryption-process hardware is reduced. This allows low power consumption due to lowered operation speed and low cost due to scale-down in hardware logic.

In the meanwhile, although the above explanation was on the example of MPEG data (motion image data), there is no limitation to motion image data.

For example, where the digital content is JPEG data (still image data), it is possible to use an encryption method similar to the I frame data encryption method described above.

Meanwhile, where the digital content is MPEG data (audio data) for example, band division is made on audio data to carry out coding independently for each divided frequency component. Therefore, encryption may be carried out on the low frequency component only, encryption on the high frequency component only or encryption at an interval of several samples. By controlling data contamination degree in this manner, it is possible to generate reproduced sound that is discordant to some degree.

Now, explanation will be made on the detail of output-route encrypting operation.

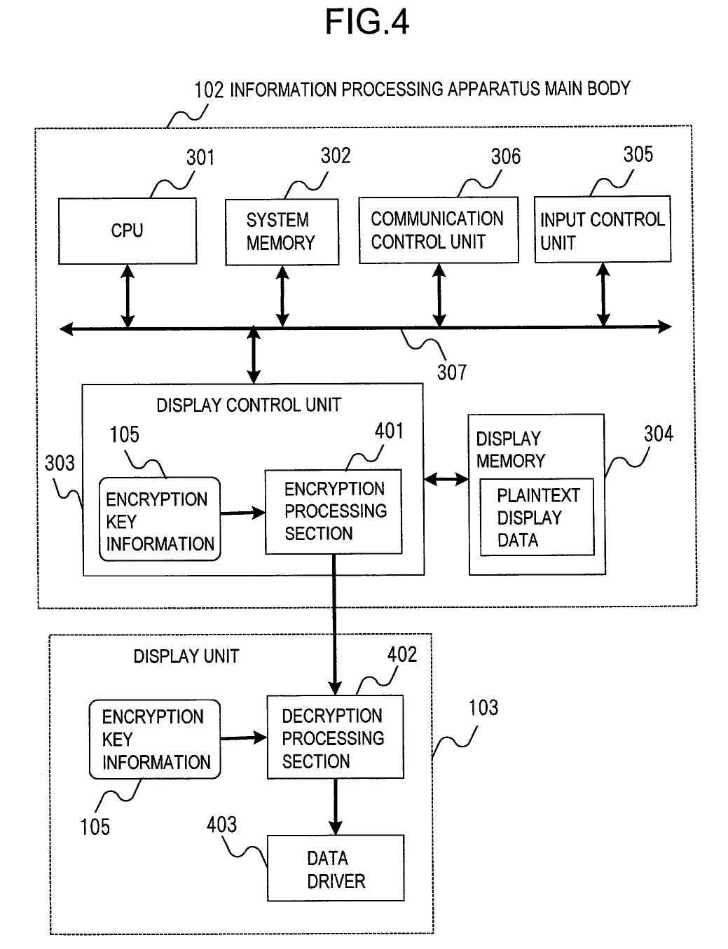

First, the schematic operation of the information processing apparatus 101 of the embodiment will be explained using FIG. 4.

FIG. 4 is a schematic configuration diagram of an information processing apparatus according to the embodiment.

FIG. 4 shows only a display-concerned section of the information processing apparatus 101, such as a PC, in a part concerning an output route encrypting operation.

In the figure, the same constituting units as those of FIG. 3 are attached with the same reference numerals. There are provided a encryption processing section 401, a decryption processing section 402 and a data driver 403.

Herein, the display unit 103 is given a digital-input display unit, e.g. a liquid crystal display (LCD) device or a CRT (cathode ray tube) device with digital/analog conversion function.

In FIG. 4, the display data (plaintext display data), containing the digital content developed within the display control unit 303 by the distribution-route encrypting operation, is stored to the display memory 304 according to an instruction by the CPU 301.

In the display control unit 303, the plaintext display data stored in the display memory 304 is inputted to the encryption processing section 401. The encryption procession section performs an encryption process 109 on a part of the input plaintext display data by using the encryption key information 105 held within the display control unit 303, thereby obtaining encrypted display data within the display control unit 303. The obtained encrypted display data is inputted from the display control unit 303 to the display unit 103.

Subsequently, in the display control unit 103, the decryption processing section 402 performs a decryption process 110 on the encrypted part of the inputted and encrypted display data by using the encryption key information 105 held within the display unit 103, obtaining plaintext data in the display unit 103. Then, the data driver 403 supplies the plaintext data decrypted by the decryption processing section 402 to each display-pixel on the display panel, thereby carrying out a display process 111 on the plaintext display data.

The above operation corresponds to output-route encrypting operation.

Note that the encryption processing section 402 may be implemented as hardware in the display control unit 303 or mounted as software by providing its own CPU and memory within the display control unit 303.

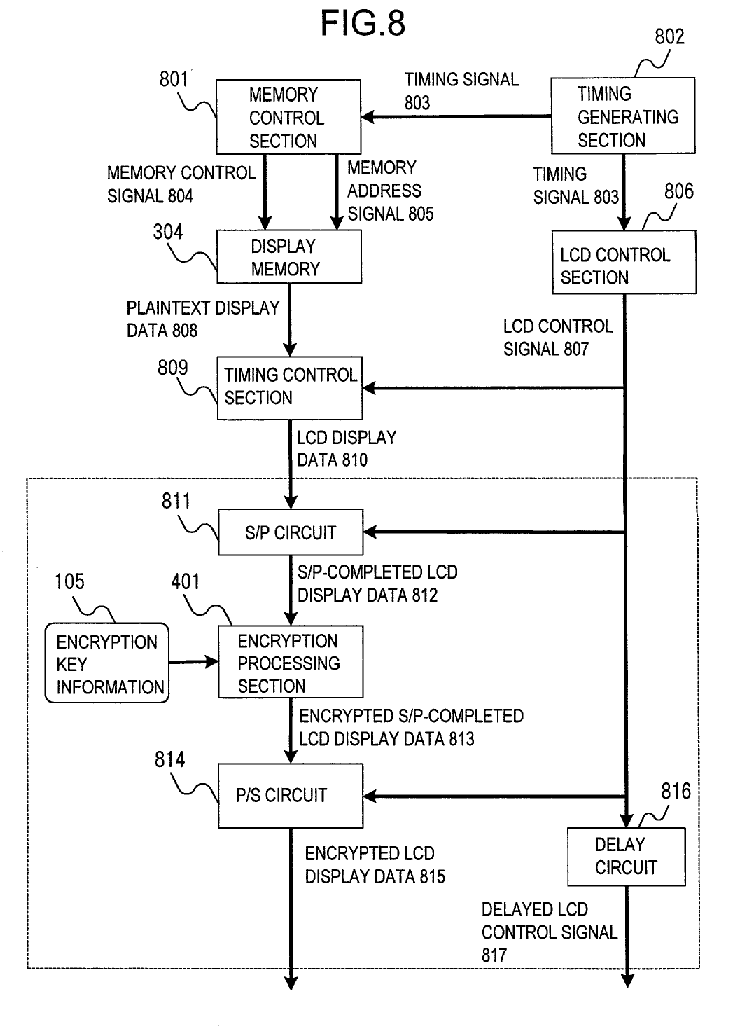

Now, explanation will be made on the schematic operation of the display control unit 303 according to the embodiment, using FIG. 8.

FIG. 8 is a schematic configuration diagram of the display control unit 303 of the embodiment.

FIG. 8 shows only a part concerning output-route encrypting operation of the display control unit 303.

In the figure, 801 is a memory control section, 802 a timing generating section, 803 a timing signal, 804 a memory control signal, 805 a memory address signal, 304 a display memory, 806 an LCD control section, 807 an LCD control signal, 808 plaintext display data, 809 a timing control section, 810 LCD display data, 811 a serial/parallel converting circuit (S/P circuit), 812 S/P-completed LCD display data, 813 encrypted-S/P-completed LCD display data, 814 a parallel/serial converting circuit (P/S circuit), 815 encrypted LCD display data, 816 a delay circuit, and 817 a delayed LCD control signal.

In FIG. 8, the memory control section 801 generates a memory control signal 804 and memory address signal 805 by using a timing signal 803 sent from the timing generating section 802, to sequentially read plaintext display data 808 out of the display memory 304.

On the other hand, the LCD control section 806 generates an LCD control signal 807 for controlling the LCD-display timing by using a timing signal 803 sent from the timing generating section 802.

The timing control section 809 forwards, as LCD display data 810, the plaintext (display) data 808 read out of the display memory 304, in display timing given by the LCD control signal 806.

Namely, the plaintext display data 808 read out of the display memory 304 is changed to LCD display data 810 synchronous with the LCD control signal 807 by the timing control section 809.

For example, assuming that a pixel of display data is transferred synchronously with one data-transfer clock of the LCD control signal 807 wherein one pixel be configured with 16-bit data, the LCD display data 810 requires a 16-bit data bus width. Herein, where a block cipher, e.g. DES is used in the encryption process, the encryption processing section 401 uses encryption key information 105 to perform a block encryption process in the blocks of 64 bits.

In order to absorb the difference between the transfer unit of LCD data 810 and the processing unit of block encryption 401, the display control unit 303 of the embodiment uses the S/P circuit 811 and the P/S circuit 814. The S/P circuit 811 converts the data width of the LCD display data 810 (herein, 16-bit basis) into a width based on encryption processing (herein, 64-bit basis), and supplies it as S/P-completed LCD display data 812 to the encryption processing section 401. Meanwhile, the P/S circuit 814 converts the data width of the encryption-S/P-completed LCD display data 813 having been encrypted-processed by the encryption processing section 401 into a data width of the LCD display data 810, and supplies it as encrypted LCD display data 815 to the data driver 403.

The S/P circuit 811 and P/S circuit 814 differs in configuration depending upon the data width of LCD display data 810 and encryption processing-based width by encryption processing section 401.

As shown in FIG. 8, the display control unit 303 of the embodiment has the S/P circuit 811, the encryption processing section 401 and the P/S circuit 814. The display control unit 303 of the embodiment further has the delay circuit 816 which makes the delay equivalent to the delay of the above processing. The LCD control signal 807 generated by the LCD control section 806 is delayed by the delay circuit 816, to be outputted as a delayed LCD control signal 817. As a result, the encrypted LCD display data 815 outputted from the P/S circuit 814 is supplied in synchronism with the delayed LCD control signal 817 to the data driver 403.

This makes it possible to carry out an encryption process on part of the display data in the course of processing for display timing control by the display control unit 303, i.e. to generate encrypted LCD display data 815 due to real-time encryption processing on the LCD display data 810.

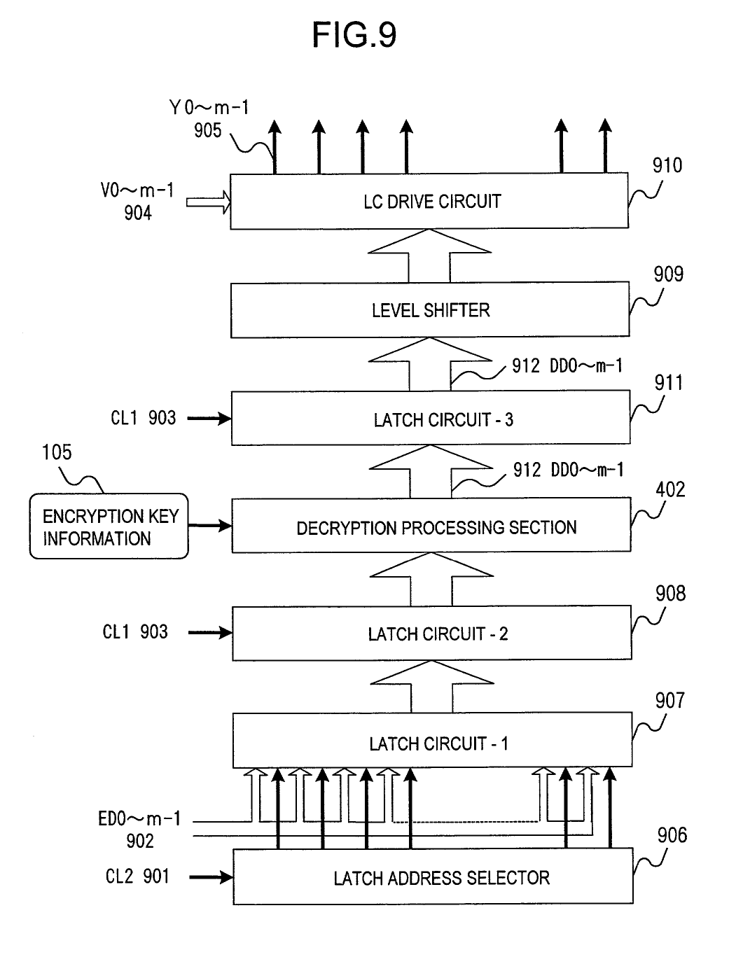

Now, explanation will be made on the schematic operation of the display unit 103 according to the embodiment with reference to FIG. 9.

FIG. 9 is a schematic configuration diagram of the display unit 103 of the embodiment.

FIG. 9 shows an example where the display unit 103 is a liquid crystal display device, showing only a part concerning output-route encrypting operation (i.e. LC-driving drain driver corresponding to the data driver 403) among the operations of the display unit 103.

In the figure, 901 is a catch signal of encrypted display data (CL2 signal), 902 encrypted display data, 903 a timing signal to output an LCD drive voltage (CL1 signal), 904 an LCD driving power source, 905 an LC-driving output signal, 906 a latch address selector, 907 a latch circuit—1, 908 a latch circuit—2, 909 a level shifter to boost from a circuit drive voltage to an LC-drive voltage, 910 an LC-drive circuit to generate a LC-drive voltage level, 911 a latch circuit—3, and 912 plaintext display data.

In FIG. 9, the latch address selector 906 counts, the fall in the CL2 signal 901 inputted from the display control unit 303 (corresponding to the delayed LCD control signal 817 shown in FIG. 8), in synchronism with the input of the encrypted display data 902, thereby generating a latch signal for the latch circuit—1 (907).

The encrypted display data 902 inputted from the display control unit 303 is held, in the input order, onto the latch circuit—1 (907) by a latch signal generated by the latch address selector 906.

The CL1 signal 903 is a horizontal synchronous signal to be inputted every line of display. The encrypted display data 902 in an amount of one line of display latched onto the latch circuit—1 (907) is latched in an amount of one line at one time onto the latch circuit—2 (908) every one-line-display period by inputting of the CL1 signal 903.

The encrypted display data 902 in an amount of one line latched on the latch circuit—2 (908) is subjected to a decryption process using the encryption key information 105 by the decryption processing section 402 into plaintext data 912. This is latched in an amount of one line at one time onto the latch circuit—3 (911) by the CL1 signal 903 every one-line-display period.

The plaintext display data 912 in an amount of one line latched on the latch circuit—3 (911) is converted into a LC-drive voltage through a level shifter 909 and LC drive circuit 910, to be applied to liquid crystal for one-line display period.

By the above operation, display operation to liquid crystal is carried out, line by line.

Herein, where the decryption process uses block cipher, e.g. DES, the decryption processing section 402 decrypts the bit data outputted from a latch circuit—2 (908) in parallel and simultaneously. For example, the LC-driving drain driver, if structured to have 1024 pixels per line and having an output of 18 bits per pixel, it has 18432 bits per line hence making 288 blocks, having 64 bits (processing on the DES basis), parallel. Then, the decryption processing section 402 uses encryption key information 105 to carry out 64-bit-based block decryption process.

This makes it possible to carry out a decryption process on a part of the display data in the course of processing for display control by LC-driving drain driver of the display unit 103, i.e. preparation and display of plaintext display data 912 by real-time decryption-processing of the encrypted display data 912.

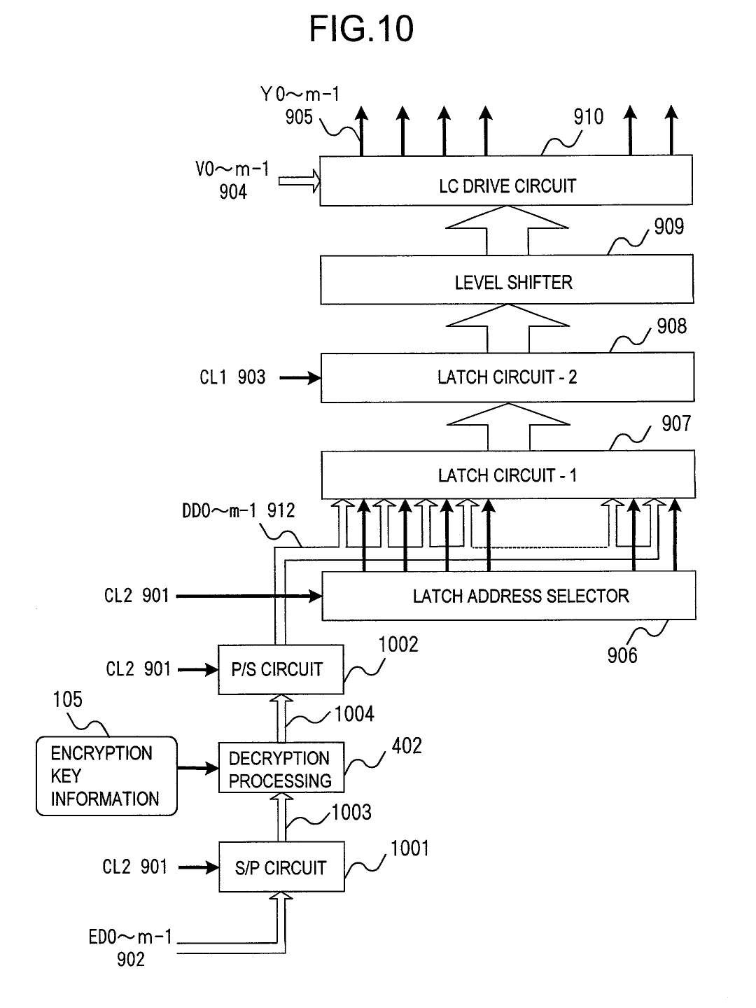

Note that the display unit 103 of the embodiment may be configured as shown in FIG. 10 instead of the configuration shown in FIG. 9.

FIG. 10 is another schematic configuration diagram of a display unit 103 according to the embodiment.

As same as FIG. 9, FIG. 10 also shows a case where the display unit 103 is a liquid crystal display device, illustrating only a part concerning output-route encrypting operation (i.e. LC-driving drain driver corresponding to the data driver 403) of the display unit 103.

In the figure, the same constituent units as those of FIG. 9 are attached with the same reference numerals. 1001 is an S/P circuit, 1002 a P/S circuit, 1003 an S/P-completed display data, and 1004 a plaintext display data.

In the display unit 103 shown in FIG. 10, the data width of encrypted display data 902 relies on data bits per pixel and data transfer clock (CL2 signal 901). Where different from the decryption-process-based data width in the decryption processing section 402, the data width of encrypted display data 902 is converted into a proper decryption-process-based data width by the S/P circuit 1001 into an S/P-completed display data 1003. Thereafter, a decryption process is made using encryption key information 105 by the decryption processing section 402. The plaintext display data 1004 obtained by the decryption process is converted into a data width of the plaintext display data 912 by the P/S circuit 1002.

As long as the decryption processing section 402 processes at least one block, it may make parallel the blocks to be processed in accordance with the bit number of encrypted display data 902 per pixel and CL2 signal 901.

In the above, explanation has been made on the output-route encrypting operation by exemplifying the case where the display unit 103 is a liquid crystal display device. However, even where the display unit 103 is, for example, a CRT device having a digital input and digital/analog converting section, preparation and display of plaintext display data is possible by carrying out a similar decryption process in the course of digital processing.

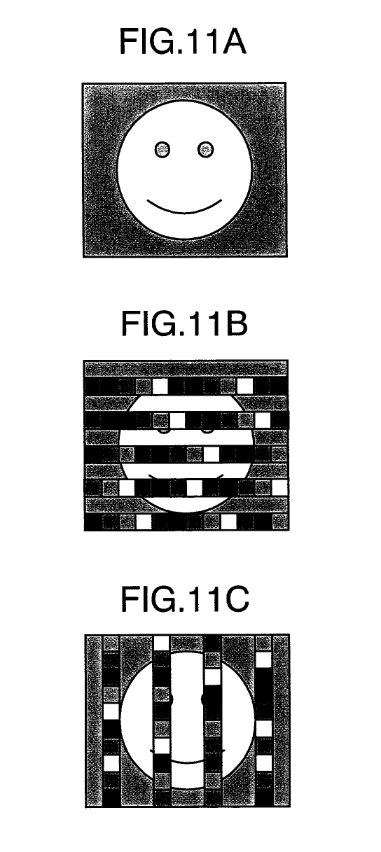

Next, explanation will be made on one example of an encrypting method, by an output-route encrypting operation, for the display data outputted from the display control unit 303, with reference to FIGS. 11 and 12.

FIG. 11 is an explanatory view showing one example of a method for encrypting the display data outputted from the display control unit 303, and showing the display image when encrypted display data is displayed on the display unit 103.

FIG. 11 shows, as a method for encrypting an original image (inherent plaintext display data), a method for performing an encryption process in a line direction and a method for performing an encryption process in a column direction.

(1) Method for Encryption in the Line Direction

For example, where carrying out encryption on the original image (inherent plaintext display data) shown in FIG. 11A by the present method, a plurality of lines (e.g. about several lines) of display data is taken as one unit in the line direction. Then, encryption process is carried out by taking a part of these obtained units as a subject of encryption process. Specifically, encryption process and no encryption process are alternately performed by unit, each comprising the plurality of lines of display data.

The display data encrypted by the present method, if subjected to the decryption process using encryption key information 105, provides an image displayed on the display unit 103 that is the same as the original image shown in FIG. 11A. However, unless the decryption process using encryption key information 105 is not made, the image displayed on the display unit 103 is the display data contaminated in several lines every other several lines as shown in FIG. 11B.

In the present method, the number of lines per unit is previously determined so that, based on the determined number of lines, the encryption processing section 401 of the display control unit 303 selectively carries out encryption while the decryption processing section 402 of the display unit 103 selectively carries out decryption. This makes it possible to contaminate part of display data and reduce the process amount of encryption/decryption in the encryption processing section 401 of the display control unit 303 and the decryption processing section 402 of the display unit 103.

Also, by increasing and decreasing the number of lines per unit, the contamination degree in display data is to be controlled. It is possible to freely change in what degree of disclosure is to do.

(2) Method for Encryption in the Column Direction

For example, where carrying out encryption on the original image (inherent plaintext display data) shown in FIG. 11A by the present method, a plurality of columns (e.g. about several columns) of display data is taken as one unit in the column direction. Encryption process is carried out by regarding a part of these obtained units as a subject of encryption process. Specifically, encryption process and no encryption process are alternately performed on unit basis, each unit comprising the plurality of lines of display data.

The display data encrypted by the present method, if subjected to the decryption process using encryption key information 105, provides an image displayed on the display unit 103 that is the same as the original image shown in FIG. 11A. However, unless performing the decryption process using encryption key information 105, the image displayed on the display unit 103 is the display data contaminated in several columns every other several lines as shown in FIG. 11C.

In the present method, the number of columns per unit is previously determined so that, based on the determined number of columns, the encryption processing section 401 of the display control unit 303 selectively carries out encryption while the decryption processing section 402 of the display unit 103 selectively carries out decryption. This makes it possible to contaminate part of display data and reduce the process amount of encryption/decryption in the encryption processing section 401 of the display control unit 303 and the decryption processing section 402 of the display unit 103.

Also, by increasing and decreasing the number of lines per unit, the contamination degree in display data is to be controlled. It is possible to freely change in what degree of disclosure is to do.

FIG. 12 is an explanatory view showing one example of an encryption method for display data outputted from the display control unit 303. FIG. 12 shows a method for encrypting a part of the display data in an amount of one pixel of the original image (inherent plaintext display data).

In this method, encryption is performed only on the higher-order bit of the display data within one pixel, or only on the lower-order bit of the display data within one pixel.

In the case that only the higher-order bit is encrypted and the lower-order bit is remained in plaintext, change amount of the display data is increased. Consequently, if encrypted display data without decryption is displayed on the display unit 103, the degree of data contamination is high and display data is difficult in observation.

Meanwhile, when only the lower-order bit is encrypted and the higher-order bit is remained in plaintext, change amount of the display data is less. Consequently, if encrypted display data without decryption is displayed on the display unit 103, the degree of data contamination is low and flickering is observed on the screen, and rough observation is possible on the display data.

FIG. 12 showed the example that the display data in a one-pixel amount is configured by 8 bits wherein, when certain plaintext data is assumably “55h”, only the higher-order bit is encrypted to turn “55h” into “e5h” while only the lower-order bit is encrypted to turn “55h” into “52h”. In this manner, encrypting only the higher-order bit provides the greater change in amount from plaintext display data so that observation is given as a display content different furthermore.

In the present method, the contamination degree of display data can be selected by selecting whether encrypting only the higher-order bit or only the lower-order bit. Also, the processing amount of encryption/decryption can be reduced in the encryption processing section 401 of the display control unit 303 and the decryption processing section 402 of the display unit 103.

In the above, explanation was made on the method for performing an encryption process in a line direction/column direction and the method for performing an encryption process only on the higher-order/lower-order bit of the display data within one pixel. However, these methods may be arbitrarily combined.

According to the digital content distributing system of the present embodiment, the output-route encrypting operation makes it possible to protect the copyright of digital content on an output route to the display unit 103 as the final output unit, which has not been conventionally implemented.

According to the digital content distributing system of the present embodiment, the digital content (display data) is not simply encrypted in the output-route encrypting operation but the data to be encrypted is selected for partial encryption. Consequently, where there is no authorized encryption key information 105, the original image is partly contaminated. Because the digital content partly contaminated is impaired of its value, it is possible to prevent the digital content from being illegally copied. Also, the partly disclosed digital content stimulates user's visual-and-auditory desire, thus prompting the user for complete viewing.

Furthermore, according to the digital content distributing system of the present embodiment, in the output-route encrypting operation the digital content only in a part is placed under a subject of encryption process to avoid the encryption process on the entire digital content, thereby making it possible to reduce the processing amount of encryption. Incidentally, contamination degree and process amount are in a trade-off relationship, and therefore either one can be prior to the other one in accordance with the requirement.

As explained above, according to the digital content distributing system of the embodiment, the output-route encrypting operation makes it possible to stimulate user's visual-and-auditory desire while protecting copyright over the digital-content output route.

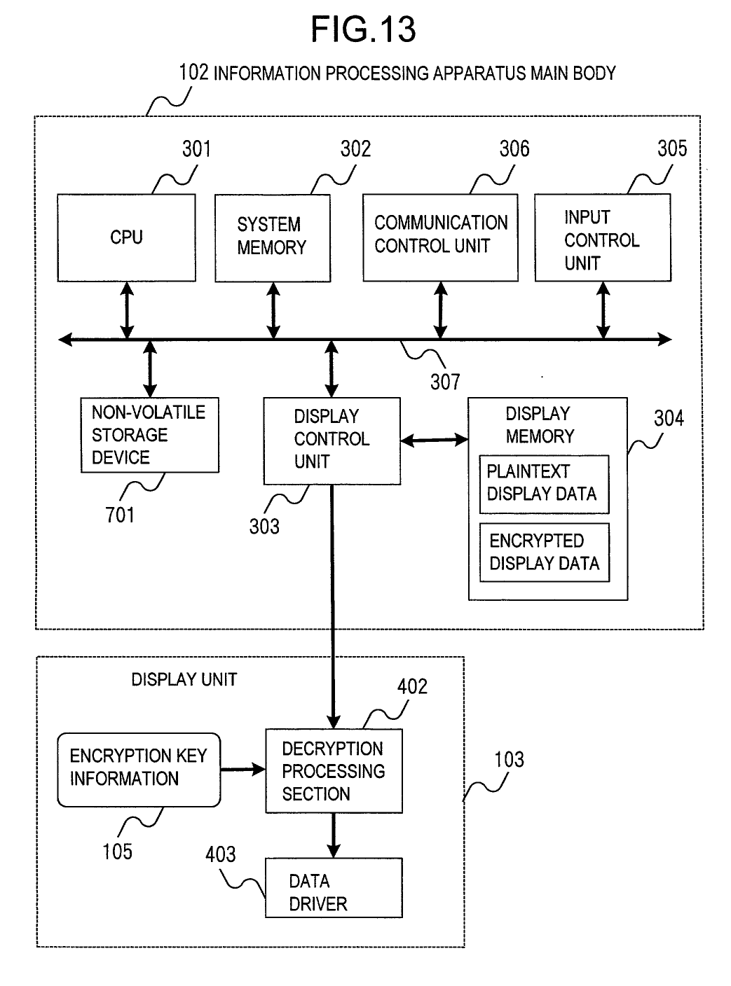

Incidentally, the information processing apparatus 101 of the embodiment may be configured as shown in FIG. 13 instead of the configuration shown in FIG. 4 to thereby realize the encryption processing section 401 shown in FIG. 4 by software.

FIG. 13 is another schematic configuration diagram of an information processing apparatus 101 according to the present embodiment.

FIG. 13 shows a section concerning display of the information processing apparatus 101 such as a PC, only in a part concerning output-route encrypting operation, similarly to FIG. 4.

In the figure, the same constituent units as those of FIG. 4 are attached with the same reference numerals. 701 is a non-volatile memory device.

In the information processing apparatus 101 having a configuration shown in FIG. 7, a CPU 301 realizes the operation of the encryption processing section 401 shown in FIG. 4 by loading and executing a program on a system memory 302. Namely, in the information processing apparatus 101 configured shown in FIG. 13, display data is encrypted by the CPU 301 instead of the display control unit 303.

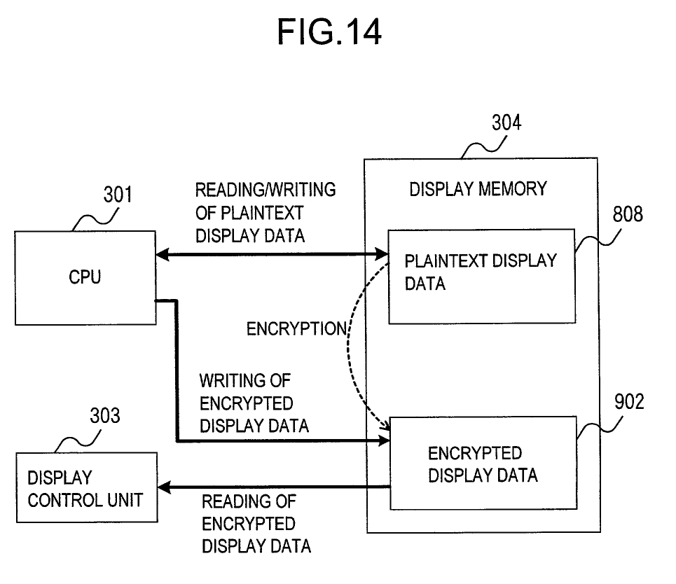

FIG. 14 is an explanatory diagram showing the schematic operation of the information processing apparatus 101 configured shown in FIG. 13.

As shown in FIG. 14, the plaintext display data 808 stored in a display memory 304 is inputted to the system memory 302 through the display control unit 303 and the data bus 307 according to an instruction by the CPU 301.

The CPU 301 carries out an encryption process 109 on the inputted plaintext display data 808 by using encryption key information 105. The encrypted display data 902 encrypted by the CPU 301 is inputted to the display memory 304 through the data bus 307 and display control unit 303. The encrypted display data 902 stored in the display memory 304 is read out by the display control unit 303 and outputted to the display unit 103.

Namely, in the information processing apparatus 101 configured shown in FIG. 13, the CPU 301 prepares plaintext data 808 on the display memory 304 and, further, prepares an encrypted display data 902, on the display memory 304, from the plaintext display data 808. The display control unit 303 performs read-out and display operations of encrypted display data 902.

Herein, although the encryption key information 105 in the explanation using FIG. 4 was held within the display control unit 303, the encryption key information 105 in the information processing apparatus 101 configured shown in FIG. 13 is held in the non-volatile memory device 701.

Meanwhile, although the information processing apparatus 101 of the embodiment both in FIG. 4 and FIG. 13 is configured, having the information processing apparatus main body 102 and the display unit 103, the information processing apparatus main body 102 may be integral with the display unit 103, as is the case in explanation for distribution-route encrypting operation. Namely, the information processing apparatus 101 of the embodiment may be a portable information terminal termed so-called PDA or the like.

As described above, because generally the portable information terminal is often configured using a CPU comparatively low in performance or memory small in capacity, there is a problem that encryption process as a comparatively heavy process imposes large burden on the portable information terminal.

Accordingly, by utilizing a portable information terminal, although having such a problem, in the digital content distributing system of the embodiment, the digital content encrypted not wholly but partly can be dealt with. This can realize the both of copyright protection and user's visual-and-auditory desire as aimed at by the invention, and in addition, obtain a load-reducing effect due to the reduction in encryption processing amount. Particularly, where the portable information terminal realizes the encryption process on software, there is no need to mount a high-performance CPU or great-capacity memory for encryption processing, thereby resulting in reduction in cost and power consumption. Meanwhile, when the portable information terminal has the hardware exclusive for encryption processing, the processing speed required for the encryption-process-exclusive hardware is reduced. This allows a lower operation speed and scale reduction of hardware logic, leading to low power consumption and cost reduction.

In the meanwhile, the above explanation, although made on the example of output onto the digital display unit, is not necessarily applied to display only.

For example, in a sound output unit having a digital input, output-unit route encrypting operation can be realized by similarly carrying out encryption, at an interval of several samples, on the PCM (Pulse Code Modulation) coded sound data.

As explained above, the digital content distributing system of the embodiment carries out an encryption process on a part of a digital content in a manner relying upon the format of the digital content, thereby providing a partly contaminated digital content when no authorized encryption key information is given. Thus, it is possible to stimulate user's visual-and-auditory desire while protecting the copyright of a digital content.

Consequently, the digital content distributing system of the embodiment makes it possible to market a value-added digital content, with safety, on a semiconductor storage medium or over a digital network, thus making feasible application to digital-content distributing service and the like.

Incidentally, in digital-content protection it is satisfactory that the system uses either one of distribution route encrypting operation or output route encrypting operation. Otherwise, the both may be combined to provide a system that digital content is protected by the two independent encryption schemes.

As explained above, the present invention protects digital-content copyright, and at the same time allows final output of the digital content, which stimulates user's visual-and-auditory desire.

What is claimed is:

1. An information processing apparatus at least having a processing unit and an output unit, wherein
said processing apparatus comprises:
an encryption processing device for performing an encryption process on a digital content by using encryption key information shared with said output unit; and
a transfer device for transferring the encrypted digital content to said output unit, and
said output unit comprises:
an input device for inputting the digital content transferred from said processing apparatus;
a decryption processing device for performing a decryption process on the inputted digital content by using the encryption key information shared with said processing apparatus; and
an output device for outputting the digital content decrypted from the encrypted part.

2. An information processing apparatus at least having a processing unit and an output unit, wherein
said processing apparatus comprises:
an encryption processing device for performing an encryption process on a part of a digital content by using encryption key information shared with said output unit; and
a transfer device for transferring the partly encrypted digital content to said output unit, and
said output unit comprises:
an input device for inputting the digital content transferred from said processing apparatus;
a decryption processing device for performing a decryption process on the inputted digital content by using the encryption key information shared with said processing apparatus; and
an output device for outputting the digital content decrypted from an encrypted part.

3. An information processing apparatus at least having a processing unit and an output unit, wherein
said processing apparatus comprises:
an input device for inputting an encrypted digital content;
an decryption processing device for performing a decryption process on the inputted digital content by using encryption key information for decrypting the digital content;
an encryption processing device for performing an encryption process on a part of the decrypted digital content by using the encryption key information shared with said output unit; and
a transfer device for transferring the encrypted digital content to said output unit;
said output unit comprising:
an input device for inputting the digital content transferred from said processing apparatus;
a decryption processing device for performing a decryption process on the inputted digital content by using the encryption key information shared with said processing apparatus; and
an output device for outputting the digital content decrypted from an encrypted part.

4. An information processing apparatus comprising:
an input device for inputting an encrypted digital content;
an decryption processing device for performing a decryption process on the inputted digital content by using encryption key information for decrypting the digital content;
an encryption processing device for performing an encryption process on a part of the decrypted digital content by using encryption key information shared with a destination output unit; and
a transfer device for transferring a partly encrypted digital content to said output unit.

5. An information processing apparatus according to claim 4, wherein the digital content to be inputted by said input device is encrypted, with a formatting unit of the digital content in plaintext taken as one unit, in a part of the units as a subject of encryption.

6. An information processing apparatus according to claim 2, wherein said encryption processing device performs an encryption process, with a formatting unit of the digital content in plaintext taken as one unit, on a part of the units as a subject of encryption processing.

7. An information processing apparatus according to claim 2, wherein, in the case that said output unit is a sound reproducing unit, said encryption processing device performs an encryption process, with a plurality of samples of sound data taken as one unit, on sound data to be outputted to said sound reproducing unit in a part of the sound data units as a subject of encryption processing.

8. An information processing apparatus according to claim 2, wherein, in the case that said output unit is a display unit, said encryption processing device performs an encryption process, with a plurality of lines of display data taken as one unit, on a part of the display data units as a subject of encryption in a line direction of the display data to be outputted to said display unit, or performs an encryption process, with a plurality of columns of display data taken as one unit, on a part of the display data units as a subject of encryption in a column direction of the display data to be outputted to said display unit.

9. An information processing apparatus according to claim 2, wherein, in the case that said output unit is a display unit, said encryption processing device performs an encryption process, with data in an amount of one pixel of display data to be outputted to said display unit taken as one unit, on one part, as a subject of encryption processing, of a part of or an entirety of the display data units.

10. A display unit comprising:
an input device for inputting encrypted display data;
a decryption processing device for performing a decryption process on the inputted display data by using encryption key information shared with an information processing apparatus as a transfer destination of the display data; and
a display device for displaying display data decrypted from an encrypted part.

11. A display unit according to claim 10, wherein a digital content to be inputted by said input device is encrypted, with a plurality of lines of display data taken as one unit, in a part of the display data units as a subject of encryption processing in a line direction of the display data in plaintext, or, with a plurality of columns of display data taken as one unit, in a part of the display data units as a subject of encryption processing in a column direction of the display data in plaintext.

12. A display unit according to claim 10, wherein a digital content to be inputted by said input device is encrypted, with data in an amount of one pixel of display data in plaintext taken as one unit, on one part, as a subject of encryption processing, of a part of or the entirety of the display data units.

13. A digital content distributing system having a digital content distributing apparatus for distributing a digital content and an information processing apparatus for transferring and outputting the digital content distributed from the digital content distributing apparatus to an output unit, wherein:
said digital content distributing apparatus comprises:
a storage device storing a digital content partly encrypted by using first encryption key information shared with said information processing apparatus; and
a distributing device for distributing the stored digital content to said information processing apparatus,
said information processing apparatus comprises:
an input device for inputting the digital content distributed from said digital content distributing apparatus;
a decryption processing device for performing a decryption process on an encrypted part of the inputted digital content by using the first encryption key information;
an encryption processing device for performing an encryption process on a part of the digital content decrypted from the encrypted part by using second encryption key information shared with said output unit; and
a transfer device for transferring the encrypted digital content to said output unit, and
said output unit comprises:
an input device for inputting the digital content transferred from said information processing apparatus;
a decryption processing device for performing a decryption process on an encryption part of the inputted digital content by using the second encryption key information;
an output device for outputting the digital content decrypted from the encrypted part;
wherein said encryption processing device of said digital content distributing apparatus and said encryption processing device of said information processing apparatus perform an encryption process, with a formatting unit of the digital content in plaintext taken as one unit, on a part of the units as a subject of encryption processing.

14. A method for distributing a digital content from a digital content distributing apparatus to an information processing apparatus and outputting the distributed digital content by an output unit, in a digital content distributing system having the digital content distributing apparatus for distributing the digital content and the information processing apparatus for transferring and outputting the digital content distributed from the digital content distributing apparatus to the output unit, said method comprising the steps of:
distributing, by said digital content distributing apparatus, a digital content partly encrypted by using first encryption key information shared with said information processing apparatus, to said information processing apparatus;
performing, by said information processing apparatus, a decryption process, using the first encryption key information, on an encrypted part of the digital content distributed from said digital content distributing apparatus, and an encryption process, using second encryption key information shared with said output unit, on a part of a digital content decrypted in the encrypted part, and then transferring the encrypted digital content to said output unit;
performing a decryption process, using the second encryption key information, on an encrypted part of the digital content transferred from said information processing apparatus and outputting a digital content decrypted in an encrypted part, by said output unit;
wherein the digital content to be distributed by said digital content distributing apparatus and the digital content to be transferred by said information processing apparatus are encrypted, with a formatting unit of the digital content in plaintext taken as one unit, on a part of the formatting units as a subject of encryption.
